(19) United States
(12) Patent Application Publication
(10) Pub. No.: US 2025/0315038 A1
(43) Pub. Date: Oct. 9, 2025

(54) ROBUST REMAINING USEFUL LIFE ESTIMATION BASED ON ADAPTIVE SYSTEM REPRESENTATION USING JACOBIAN FEATURE ADAPTATION

(71) Applicant: Schlumberger Technology Corporation, Sugar Land, TX (US)

(72) Inventors: Indranil Roychoudhury, Menlo Park, CA (US); Prasham Sheth, Menlo Park, CA (US)

(21) Appl. No.: 19/170,428

(22) Filed: Apr. 4, 2025

Related U.S. Application Data
(60) Provisional application No. 63/574,942, filed on Apr. 5, 2024.

(51) Int. Cl. G05B 23/02

(52) U.S. Cl. CPC G05B 23/0283; G05B 23/024

(57) ABSTRACT

Systems and methods for estimating Remaining Useful Life (RUL) of equipment based on adaptive system representation, for example, using Jacobian Feature Adaptation are presented herein. The systems and methods presented herein demonstrate a workflow to utilize an adaptation technique (offline as well as online) in order to have a more accurate and robust estimation of RUL of equipment for data-driven and hybrid models without needing to build multiple fault propagation models or having to retrain the model from scratch after collecting a sufficient amount of failure data, and demonstrate the application of the online and offline adaptation algorithms on applications relevant to the oil and gas industry, such as membranes, compressors, and so forth.

### CROSS-REFERENCE TO RELATED APPLICATIONS

This application claims priority to and benefit of U.S. Provisional Patent Application No. 63/574,942, filed on Apr. 5, 2024, which is incorporated by reference herein in its entirety.

### FIELD OF THE INVENTION

Aspects of the disclosure relate to systems and methods for estimating Remaining Useful Life (RUL) of equipment based on adaptive system representation, for example, using Jacobian Feature Adaptation.

### BACKGROUND INFORMATION

The accurate and robust prediction of Remaining Useful Life (RUL) is one of the most important functions of Prognostics and Health Monitoring (PHM) of assets, where RUL is defined as the duration of time a system has before it can no longer function nominally. Knowing how much useful time a system has remaining can help plan for mitigating the effects of such failures rather than having to react to them. For example, the knowledge about RUL for a particular system helps in decision-making by providing necessary information using which replacement activities can be planned beforehand, thereby supporting the seamless operation of a facility.

### SUMMARY

A summary of certain embodiments described herein is set forth below. It should be understood that these aspects are presented merely to provide the reader with a brief summary of these certain embodiments and that these aspects are not intended to limit the scope of this disclosure.

In one non-limiting embodiment, a method includes initially training, via an analysis and control system, a model of a physical system. The model includes a data-driven model or a hybrid model that includes a combination of a physics-based definition of the physical system and data collected relating to the physical system. The method also includes detecting, via the analysis and control system, deviations of one or more outputs of the model of the physical system relative to data collected by one or more sensors associated with the physical system during operation of the physical system. The method further includes determining, via the analysis and control system, that degradation in an ability of the model of the physical system to estimate performance of the physical system has occurred based at least in part on the detected deviations. In addition, the method includes utilizing, via the analysis and control system, transfer learning or adaptation techniques of the model of the physical system to adapt the model of the physical system. The method also includes estimating, via the analysis and control system, a Remaining Useful Life (RUL) of the physical system based on the adapted model of the physical system.

In another non-limiting embodiment, an analysis and control system includes one or more processors configured to execute processor-executable instructions stored in memory of the analysis and control system. The processor-executable instructions, when executed by the one or more processors, cause the analysis and control system to initially train a model of a physical system, wherein the model of the physical system includes a data-driven model or a hybrid model that includes a combination of a physics-based definition of the physical system and data collected relating to the physical system; to detect deviations of one or more outputs of the model of the physical system relative to data collected by one or more sensors associated with the physical system during operation of the physical system; to determine that degradation in an ability of the model of the physical system to estimate performance of the physical system has occurred based at least in part on the detected deviations; to utilize transfer learning or adaptation techniques of the model of the physical system to adapt the model of the physical system; and to estimate a RUL of the physical system based on the adapted model of the physical system.

In yet another non-limiting embodiment, a non-transitory computer readable medium includes processor-executable instructions, which when executed by one or more processors of an analysis and control system, cause the analysis and control system to initially train a model of a physical system, wherein the model of the physical system includes a data-driven model or a hybrid model that includes a combination of a physics-based definition of the physical system and data collected relating to the physical system; to detect deviations of one or more outputs of the model of the physical system relative to data collected by one or more sensors associated with the physical system during operation of the physical system; to determine that degradation in an ability of the model of the physical system to estimate performance of the physical system has occurred based at least in part on the detected deviations; to utilize transfer learning or adaptation techniques of the model of the physical system to adapt the model of the physical system; and to estimate an RUL of the physical system based on the adapted model of the physical system.

### BRIEF DESCRIPTION OF THE DRAWINGS

Various aspects of this disclosure may be better understood upon reading the following detailed description and upon reference to the drawings, in which:

FIG. 1 illustrates an example oil and gas production system, in accordance with embodiments of the present disclosure;

FIG. 2 depicts a production control system configured to control the oil and gas production system of FIG. 1, in accordance with embodiments of the present disclosure;

FIG. 3 illustrates a workflow describing how an adaptation technique can adapt a model that is trained/learned in a controlled setting to predict Remaining Useful Life (RUL) of equipment, in accordance with embodiments of the present disclosure;

FIGS. 4A and 4B illustrate more algorithmic details of the M.fit( ), M.model_drift_detector( ), M.adapt( ), and RUL Estimator blocks of the workflow of FIG. 3, in accordance with embodiments of the present disclosure; and

FIG. 5 illustrates a flow diagram of a method for estimating an RUL of a physical system based on adaptive system representation, in accordance with embodiments of the present disclosure.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to describe certain embodiments more clearly.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, it will be appreciated that the analysis and control system described herein may be configured to perform any and all of the data processing functions described herein automatically.

In addition, as used herein, the term “substantially similar” may be used to describe values that are different by only a relatively small degree relative to each other. For example, two values that are substantially similar may be values that are within 10% of each other, within 5% of each other, within 3% of each other, within 2% of each other, within 1% of each other, or even within a smaller threshold range, such as within 0.5% of each other or within 0.1% of each other.

Remaining Useful Life (RUL) of equipment may be predicted via predictive maintenance algorithms. Typically, there are a few approaches to predicting the RUL of a system: (a) model-based approaches, (b) data-driven approaches, or (c) hybrid models that combine model-based with data-driven techniques. In model-based approaches, the system is typically represented as a set of equations governing the operation of the particular system, and one needs a nominal model of the system as well as multiple fault progression models. One has to first detect and isolate the fault and quantify the fault magnitude, and using this fault magnitude as a starting point, simulate the fault progression model into the future to estimate the RUL. More often than not, it is relatively difficult to reduce the possible fault models to one fault and, hence, multiple fault progression models have to be simulated in time, which is not computationally efficient. With the rise of data-driven methods, it is also possible to learn the representation of a system using completely data-driven methods, as well as using a hybrid combination of the physical representation and data-driven methods. Data-based approaches (with a sufficiently large number of layers and parameters) may be able to capture both the nominal as well as fault progression using one model, but typically they are re-trained after the fault has been detected and a sufficient amount of failure data has been collected, leading to a delay in RUL prediction as also computational inefficiency.

The possibility of learning hybrid models representing both the nominal and fault dynamics of the system opens up doors for updating the representation of the system with real-life data in an efficient way so as to ensure that the representation of the system is always close to the real-life system. This helps ensure that the predicted RUL is always taking into account any sort of degradation or changes in operating conditions that may impact the behavior of the physical system. The RUL predicted using such an updated system is more accurate as it is aware of the present state of the system.

Many possible methods are available that enable this “updating/adaptation” of the model, such as retraining of machine learning (ML) models, recalibration of the model parameters based on some initially collected field data, and so forth. However, many of these approaches are computationally expensive and cannot be used in dynamic, fast-changing environments that need quick recalibration requirements compared to a complete re-training of the ML model that is typically both data- and time-intensive.

Certain existing techniques, for example, the techniques for performing recalibration through Jacobian Feature Regression (JFR) of a lab-developed model to the field environment discussed in Forgione, Marco, Aneri Muni, Dario Piga, and Marco Gallieri. “On the adaptation of recurrent neural networks for system identification.” Automatica 155 (2023): 111092 (e.g., “Forgione”), present certain challenges. Forgione uses a recurrent neural network (RNN) to model the dynamic system, and this nominal RNN is trained on available measurements. Then, it is assumed that the system dynamics change, causing the nominal RNN to not be accurate enough for predicting the observed measurements in the presence of these perturbed system dynamics. In other words, an unacceptable degradation of the nominal model performance occurs. A transfer learning approach to improve the performance of the nominal model in the presence of perturbed system dynamics is proposed, where the nominal model is augmented with additive correction terms that are trained on the currently observed “perturbed-system” data; and these correction terms are learned through a JFR method “defined in terms of the features spanned by the model's Jacobian concerning its nominal parameters”.

The embodiments described herein address the shortcomings of Forgione and other similar techniques by providing an improved approach for recalibrating model parameters of retrained machine learning (ML) models based, for example, on data collected during operation of the physical systems being monitored. The embodiments described herein extend the implementation of JFR (or other suitable transfer learning or adaptation techniques) to hybrid models and demonstrates that this approach works faster and more accurately than retraining these machine learning (ML) and physics-informed machine learning (PIML) models. The other techniques are based on incoming data, fine-tuning, and using active learning-based approaches to retrain models. In addition, the other techniques also include learning corrective terms, corrective models, and full retraining of the models from scratch. In addition, the embodiments described herein extend the workflows described herein for PHM-based use cases, for example, use cases that are focused on utilizing JFR or other suitable transfer learning or adaptation techniques to improve the robustness of PHM solutions.

The embodiments described herein also demonstrate the use of such adapted models to make the RUL prediction more robust. The approach presented in Forgione inherently works in offline mode, where the adaptation happens once it is triggered based on some prior knowledge or analysis. The embodiments described herein also demonstrate how the offline adaptation approach may be modified into an online adaptation technique. In addition, using JFR for online adaptation removes the burden of modeling different fault progression models and simulating these models in parallel to predict the correct RUL. In addition, the embodiments described herein provide a workflow to utilize the adaptation technique (offline as well as online) in order to have a more accurate and robust estimation of RUL for data-driven and hybrid models without needing to build multiple fault propagation models or having to retrain the model from scratch after collecting a sufficient amount of failure data. Finally, the embodiments described herein also demonstrate the application of the online and offline adaptation algorithms on applications relevant to the oil and gas industry, such as membranes, compressors, and so forth.

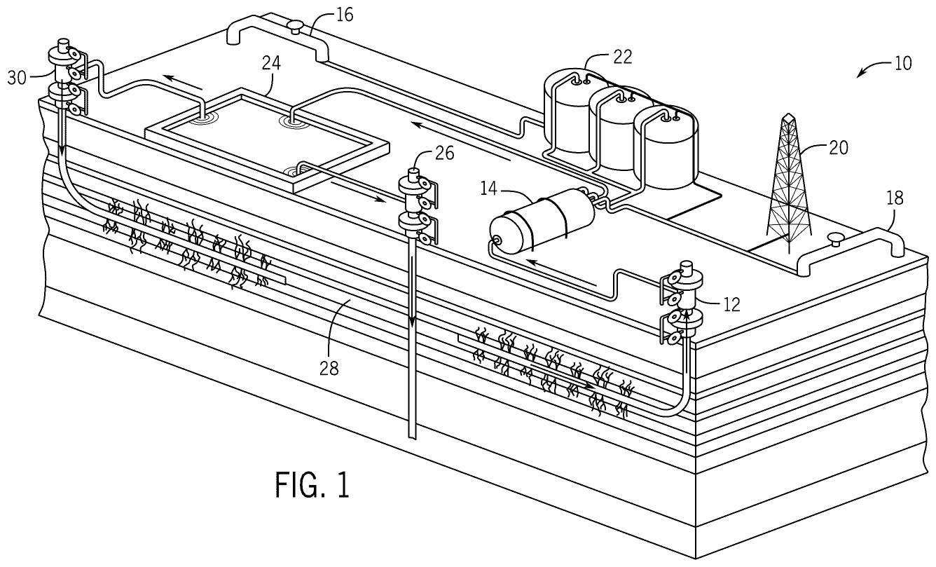

FIG. 1 illustrates an example oil and gas production system 10 having various worksite locations that contain equipment that may be monitored and controlled as described in greater detail herein. As illustrated in FIG. 1, oil and gas is produced along with water at one or more production wells 12. Then, each reservoir fluid (e.g., oil, gas, the produced water, the returned injected hydraulic fracturing fluid, and so forth) may be separated using one or more separators 14 with most of the produced oil and gas being directed into oil and gas pipelines 16, 18, respectively, and the remainder flared via a flare stack 20 and the produced water being directed to a temporary storage facility 22 for local treatment and subsequent storage in, for example, a surface pond 24. In certain embodiments, most of the produced water is re-injected into SWD wells 26 with only a small portion used for fracturing purposes via injection into a formation 28 by one or more fracturing wells 30. As described in greater detail herein, various pieces of equipment at each of the locations illustrated in FIG. 1 may be analyzed using the techniques described herein. Furthermore, the analytic techniques described herein may be extended to other types of production systems other than oil and gas production systems 10.

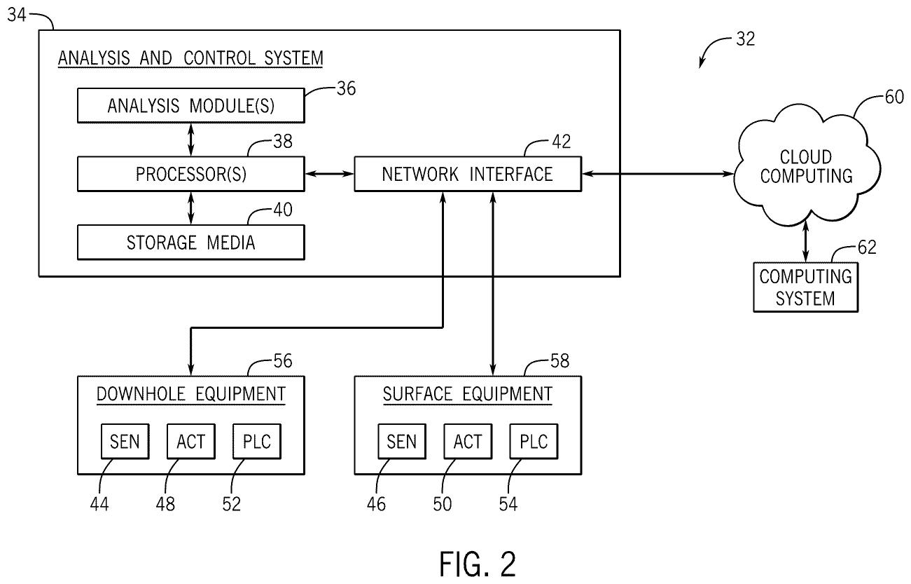

FIG. 2 illustrates a production control system 32 (e.g., that includes the analysis and control system 34) configured to control the oil and gas production system 10 of FIG. 1. In certain embodiments, the analysis and control system 34 may include one or more analysis modules 36 (e.g., a program of computer-executable instructions and associated data) that may be configured to perform various functions of the embodiments described herein. In certain embodiments, to perform these various functions, the one or more analysis modules 36 may execute on one or more processors 38 of the analysis and control system 34, which may be connected to one or more storage media 40 of the analysis and control system 34. Indeed, in certain embodiments, the one or more analysis modules 36 may be stored in the one or more storage media 40.

In certain embodiments, the computer-executable instructions of the one or more analysis modules 36, when executed by the one or more processors 38, may cause the one or more processors 38 to generate one or more models (e.g., forward model, inverse model, mechanical model, and so forth). Such models may be used by the analysis and control system 34 to predict values of operational parameters that may or may not be measured (e.g., using gauges, sensors, and so forth) during operations. In addition, the models enable automatic adjustment of control of operational parameters of equipment based on data that changes during operation of the equipment (e.g., specifically based on estimations of RUL of the equipment, as described in greater detail herein).

In certain embodiments, the one or more processors 38 may include a microprocessor, a microcontroller, a processor module or subsystem, a programmable integrated circuit, a programmable gate array, a digital signal processor (DSP), or another control or computing device. In certain embodiments, the one or more processors 38 may include machine learning and/or artificial intelligence (AI) based processors. In certain embodiments, the one or more storage media 40 may be implemented as one or more non-transitory computer-readable or machine-readable storage media. In certain embodiments, the one or more storage media 40 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the computer-executable instructions and associated data of the analysis module(s) 36 may be provided on one computer-readable or machine-readable storage medium of the storage media 40, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the one or more storage media 40 may be located either in the machine running the machine-readable instructions or may be located at a remote site from which machine-readable instructions may be downloaded over a network for execution.

In certain embodiments, the processor(s) 38 may be connected to a network interface 42 of the analysis and control system 34 to allow the analysis and control system 34 to communicate with multiple downhole sensors 44 and surface sensors 46, as well as communicate with actuators 48, 50 and/or programmable logic controllers (PLCs) 52, 54 of surface equipment 56 and of downhole equipment 58, as described in greater detail herein. In certain embodiments, the network interface 42 may also facilitate the analysis and control system 34 to communicate data to cloud computing resources 60, which may in turn communicate with external computing systems 62 to access and/or to remotely interact with the analysis and control system 34.

It should be appreciated that the production control system 32 illustrated in FIG. 2 is only one example of a production control system, and that the production control system 32 may have more or fewer components than shown, may combine additional components not depicted in the embodiment of FIG. 2, and/or the production control system 32 may have a different configuration or arrangement of the components depicted in FIG. 2. In addition, the various components illustrated in FIG. 2 may be implemented in hardware, software, or a combination of both hardware and software, including one or more signal processing and/or application specific integrated circuits. Furthermore, the operations of the production control system 32 as described herein may be implemented by running one or more functional modules in an information processing apparatus such as application specific chips, such as application-specific integrated circuits (ASICs), field-programmable gate arrays (FPGAs), programmable logic devices (PLDs), systems on a chip (SOCs), or other appropriate devices. These modules, combinations of these modules, and/or their combination with hardware are all included within the scope of the embodiments described herein.

As described above, the embodiments described herein build upon developed JFR algorithms by demonstrating a workflow to utilize the adaptation technique (offline as well as online) in order to have a more accurate and robust estimation of RUL of equipment 56, 58 for data-driven and hybrid models without needing to build multiple fault propagation models or having to retrain the model from scratch after collecting a sufficient amount of failure data; and demonstrating the application of the online and offline adaptation algorithms on applications relevant to the oil and gas industry, such as membranes, compressors, and so forth. In addition, the embodiments described herein also extend the implementation of JFR (or other suitable transfer learning or adaptation techniques) to physics-informed neural networks modeled using a state-space formulation; demonstrate that JFR is more sustainable than other retraining and transfer learning methods; and demonstrate how an offline adaptation approach may be modified into an online adaptation technique. Because of the wide-scale demand and applicability of estimating the RUL of a physical system (e.g., equipment 56, 58), the embodiments described herein may be useful for many applications, being particularly relevant for Asset Performance Management (APM) workflows.

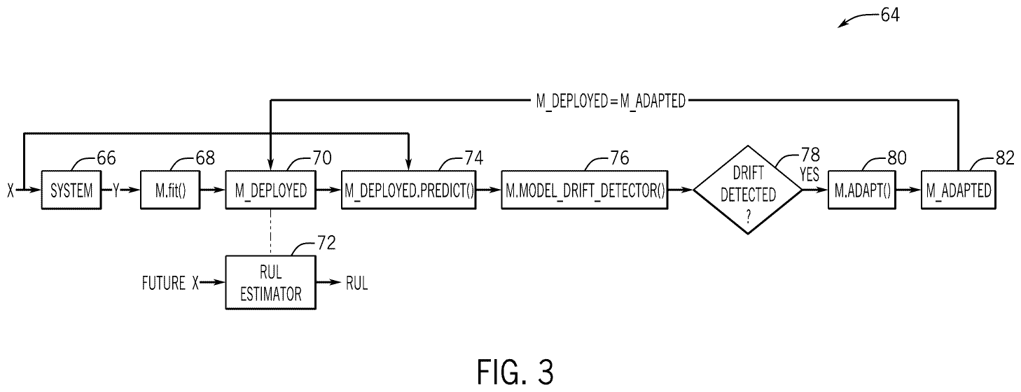

FIG. 3 illustrates a workflow 64 describing how an adaptation technique can adapt a model that is trained/learned in a controlled setting to predict RUL of equipment 56, 58. In particular, FIG. 3 presents an overall approach for using JFR (or other suitable transfer learning or adaptation techniques) for adapting models for predicting RUL. The physical system 66 can be any asset (e.g., equipment 56, 58) for which prediction of RUL is desired. Typically, input signals (denoted by X) are known and measured sensor readings (denoted by Y) are obtained via the sensors 44, 46 described above with reference to FIG. 2. From these, Model M may be built that can help predict the RUL of the physical system 66. Additionally, Model M can be based on hypothesized future inputs (denoted by Future X). As described in greater detail herein, the Model M may be trained using data-driven approaches or hybrid approaches that combine model-based with data-driven approaches. Model M may be built and trained with input-output signals using an M.fit( ) algorithm 68. Typically, nominal X and Y combinations may be used to build Model M. Once Model M is trained, it may be deployed and denoted by M_deployed model 70, and this deployed Model M may be used as an RUL Estimator 72 to predict the future outputs of the M_deployed model 70, and depending on when these outputs cross a failure threshold, determine the RUL of the physical system 66.

If there is no degradation in the physical system 66, the M_deployed model 70 would forever be able to correctly predict (denoted as M_deployed.predict( ) 74) the future observations of the physical system 66. However, engineered systems 66 eventually encounter some sort of degradation or failure. As such, one way to adapt to this changing M_deployed model 70 would be to retrain the M_deployed model 70 for every new pair of X and Y. The process of retraining the M_deployed model 70 can be computationally expensive. Hence, to intelligently call the model update, an M.model_drift_detector( ) algorithm 76 may be developed and deployed that compares the predictions of the M_deployed model 70, and the data collected by the sensors 44, 46 associated with the physical system 66 to see if there is a statistically significant drift between the predicted and observed sensors. If there is a significantly significant drift (determined at block 78), then while there are many reasons for which this drift could occur, the drift may be attributed to degradation in the physical system 66 that are not captured by the M_deployed model 70 anymore, and the parameters of this M_deployed model 70 need to be re-calibrated or adapted to the newly observed data collected by the sensors 44, 46. If that is the case, then the JFR algorithm (denoted by the M.Adapt( ) function 80) may be used to adapt the M_deployed model 70 to the new data observed. This adapted model is denoted as M_adapted 82 and now replaces the M_deployed model 70, and the process continues as significant deviation is detected in the sensor readings predicted by the M_deployed model 70 and the observed sensor readings associated with the physical system 66. It will be appreciated whether any such deviations are significant enough to consider that substantial degradation in the ability of the M_deployed model 70 to estimate the actual sensor readings for the system 66 may be based on whether the deviations in predicted versus actual values of the sensor readings are greater than predetermined thresholds.

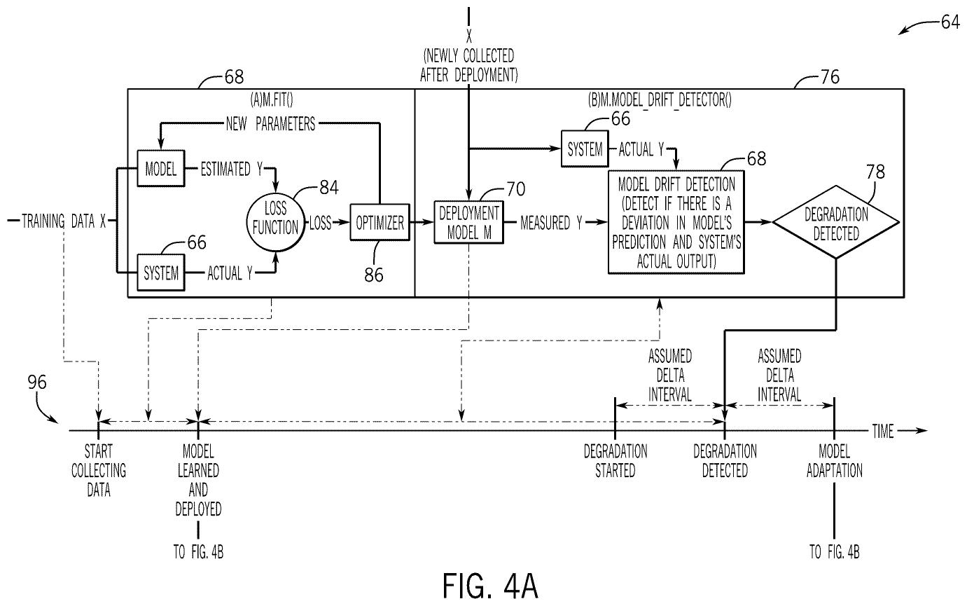

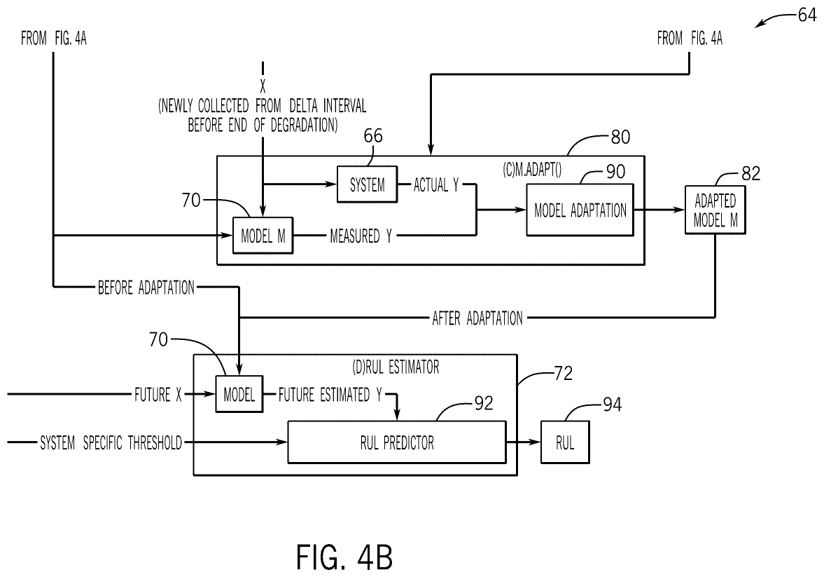

FIGS. 4A and 4B illustrate more algorithmic details of the M.fit( ) 68, M.model_drift_detector( ) 76, M.adapt( ) 80, and RUL Estimator 72 blocks of the workflow 64 of FIG. 3. As illustrated in FIG. 4A, the M.fit( ) algorithm 68 may take the training data X, and compare the estimated outputs Y from the M_deployed model 70 versus the actual sensor reading outputs Y (e.g., as collected by the sensors 44, 46) with reference to a loss function 84, which feeds loss into an optimizer algorithm 86 to determine the M_deployed model 70. In addition, the M.fit( ) algorithm 68 may utilize newly collected parameter data to continuously update the M_deployed model 70.

Then, the M_deployed model 70 may receive newly collected inputs X after deployment, which may be used to determine measured outputs Y on which drift detection 88 may be performed by the M.model_drift_detector( ) 76 to detect if there are any deviations in the prediction of the M_deployed model 70 and the actual output associated with the physical system 66. If degradation is detected (e.g., in block 78), then the M_deployed model 70 may be adapted by the M.Adapt( ) function 80 using data collected from the sensors 46, 48 before and after the degradation to determine measured outputs Y on which the model adaptation 90 (using the JFR algorithm) of the M.Adapt( ) function 80 may adapt the M_deployed model 70 to generate the M_adapted model 82.

Finally, the M_deployed model 70 (e.g., before adaptation) or the M_adapted model 82 (e.g., after adaptation) may use future inputs X to generate future outputs Y, which may be used by an RUL predictor algorithm 92 of the RUL Estimator 72 to determine an RUL 94 of the physical system 66 based at least in part on a system-specific threshold.

FIG. 4A also illustrates an example timeline 96 for use of the workflow 64 illustrated in FIGS. 3, 4A, and 4B over time. For example, the timeline 96 illustrates points in time where the analysis and control system 34 begins collecting data (e.g., using the sensors 46, 48 described here), when the analysis and control system 34 learns and deploys the model, when degradation of the model may be assumed to have started, when the degradation of the model is detected by the analysis and control system 34, and when the model is adapted by the analysis and control system 34, as described in greater detail herein.

As such, the embodiments described herein enable the determination of RUL of physical systems 66 (e.g., equipment 56, 58) based on hybrid models (e.g., a combination of a physics-based definition of the physical systems 66 and data collected relating to the physical systems 66) that are adapted (e.g., automatically, in certain embodiments) based on JFR of the hybrid models when degradations of the hybrid models of the physical systems 66 are detected (e.g., automatically, in certain embodiments). The embodiments described herein may be extended to any applications requiring the use of RUL. Integrating the proposed techniques in such applications may help enhance the overall effectiveness of the applications.

In one embodiment, utilizing the adaptation techniques described herein leads to substantially improved root mean square error (RMSE) and R² results.

The embodiments described herein provide improvements over existing technologies insofar as the showcase that the techniques utilize less power, contributing to fewer carbon emissions. The relatively fast and robust adaptation of the hybrid models enable the hybrid models to be “evergreen” and “constantly updated”, for example, adapting to wear and tear and other degradation of the physical systems 66. As a result, the embodiments described herein make PHM processes more reliable by ensuring that the models of the physical systems 66 are continuously adapted to reflect the most up-to-date and true representation of the state of the physical systems 66.

In addition, the embodiments described herein help ensure that the prediction of RUL always considers any sort of degradation or changes in operating conditions that may impact the behavior of the physical systems 66. The RUL predicted using such an updated physical system 66 is more accurate as it is aware of the present state of the physical system 66. Furthermore, accurate and robust estimation of RUL helps in optimizing the overall decision-making process.

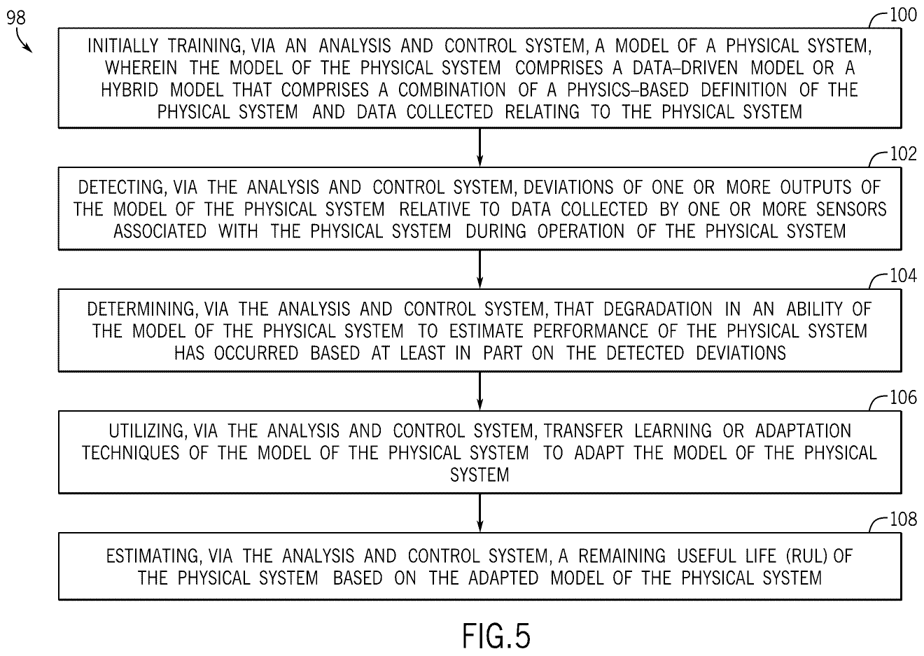

FIG. 5 illustrates a flow diagram of a method 98 (e.g., to be at least partially performed by the analysis and control system 34) for estimating RUL of a physical system 66 based on adaptive system representation, as described in greater detail herein. For example, the method 98 may include initially training, via the analysis and control system 34, a model 70 of a physical system 66. The model 70 of the physical system 66 includes a data-driven model or a hybrid model that includes a combination of a physics-based definition of the physical system 66 and data collected relating to the physical system 66 (block 100). The method 98 may also include detecting, via the analysis and control system 34, deviations of one or more outputs of the model 70 of the physical system 66 relative to data collected by one or more sensors 44, 46 associated with the physical system 66 during operation of the physical system 66 (block 102). The method 98 may also include determining, via the analysis and control system 34, that degradation in an ability of the model 70 of the physical system 66 to estimate performance of the physical system 66 has occurred based at least in part on the detected deviations (block 104). The method 98 may also include utilizing, via the analysis and control system 34, transfer learning or adaptation techniques of the model 70 of the physical system 66 to adapt the model 70 of the physical system 66 (block 106). The method 98 may also include estimating, via the analysis and control system 34, an RUL of the physical system 66 based on the adapted model 82 of the physical system 66 (block 108).

In addition, in certain embodiments, the method 98 may include utilizing, via the analysis and control system 34, JFR of the model 70 of the physical system 66 to adapt the model 70 of the physical system 66. In addition, in certain embodiments, the method 98 may include automatically controlling, via the analysis and control system 34, one or more operational parameters of the physical system 66 based at least in part on the estimated RUL of the physical system 66. In addition, in certain embodiments, the method 98 may include determining, via the analysis and control system 34, that the degradation in the ability of the model 70 of the physical system 66 to estimate the performance of the physical system 66 has occurred, in response to detecting that the deviations of the one or more outputs of the model 70 of the physical system 66 relative to the data collected by the one or more sensors 44, 46 associated with the physical system 66 are greater than predetermined thresholds. In addition, in certain embodiments, the method 98 may include continuously monitoring, via the analysis and control system 34, the one or more sensors 44, 46 to automatically detect the deviations of the one or more outputs of the model 70 of the physical system 66 relative to the data collected by the one or more sensors 44, 46 associated with the physical system 66 during operation of the physical system 66. In addition, in certain embodiments, the method 98 may include utilizing, via the analysis and control system 34, the transfer learning or adaptation techniques on a state-space formulation of the model 70 of the physical system 66 to adapt the model 70 of the physical system 66. In addition, in certain embodiments, the model 70 of the physical system 66 includes an RNN.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112 (f). However, for any claims containing elements designated in any other manner, it is intended that such elements are not to be interpreted under 35 U.S.C. § 112 (f).

What is claimed is:

1. A method, comprising:
initially training, via an analysis and control system, a model of a physical system, wherein the model of the physical system comprises a data-driven model or a hybrid model that comprises a combination of a physics-based definition of the physical system and data collected relating to the physical system;
detecting, via the analysis and control system, deviations of one or more outputs of the model of the physical system relative to data collected by one or more sensors associated with the physical system during operation of the physical system;
determining, via the analysis and control system, that degradation in an ability of the model of the physical system to estimate performance of the physical system has occurred based at least in part on the detected deviations;
utilizing, via the analysis and control system, transfer learning or adaptation techniques of the model of the physical system to adapt the model of the physical system; and
estimating, via the analysis and control system, a Remaining Useful Life (RUL) of the physical system based on the adapted model of the physical system.

2. The method of claim 1, comprising utilizing, via the analysis and control system, Jacobian Feature Regression (JFR) of the model of the physical system to adapt the model of the physical system.

3. The method of claim 1, comprising automatically controlling, via the analysis and control system, one or more operational parameters of the physical system based at least in part on the estimated RUL of the physical system.

4. The method of claim 1, comprising determining, via the analysis and control system, that the degradation in the ability of the model of the physical system to estimate the performance of the physical system has occurred, in response to detecting that the deviations of the one or more outputs of the model of the physical system relative to the data collected by the one or more sensors associated with the physical system are greater than predetermined thresholds.

5. The method of claim 1, comprising continuously monitoring, via the analysis and control system, the one or more sensors to automatically detect the deviations of the one or more outputs of the model of the physical system relative to the data collected by the one or more sensors associated with the physical system during operation of the physical system.

6. The method of claim 1, comprising utilizing, via the analysis and control system, the transfer learning or adaptation techniques on a state-space formulation of the model of the physical system to adapt the model of the physical system.

7. The method of claim 1, wherein the model of the physical system comprises a recurrent neural network (RNN).

8. An analysis and control system, comprising:
one or more processors configured to execute processor-executable instructions stored in memory of the analysis and control system, wherein the processor-executable instructions, when executed by the one or more processors, cause the analysis and control system to:
initially train a model of a physical system, wherein the model of the physical system comprises a data-driven model or a hybrid model that comprises a combination of a physics-based definition of the physical system and data collected relating to the physical system;
detect deviations of one or more outputs of the model of the physical system relative to data collected by one or more sensors associated with the physical system during operation of the physical system;
determine that degradation in an ability of the model of the physical system to estimate performance of the physical system has occurred based at least in part on the detected deviations;
utilize transfer learning or adaptation techniques of the model of the physical system to adapt the model of the physical system; and
estimate a Remaining Useful Life (RUL) of the physical system based on the adapted model of the physical system.

9. The analysis and control system of claim 8, wherein the processor-executable instructions, when executed by the one or more processors, cause the analysis and control system to utilize Jacobian Feature Regression (JFR) of the model of the physical system to adapt the model of the physical system.

10. The analysis and control system of claim 8, wherein the processor-executable instructions, when executed by the one or more processors, cause the analysis and control system to automatically control one or more operational parameters of the physical system based at least in part on the estimated RUL of the physical system.

11. The analysis and control system of claim 8, wherein the processor-executable instructions, when executed by the one or more processors, cause the analysis and control system to determine that the degradation in the ability of the model of the physical system to estimate the performance of the physical system has occurred, in response to detecting that the deviations of the one or more outputs of the model of the physical system relative to the data collected by the one or more sensors associated with the physical system are greater than predetermined thresholds.

12. The analysis and control system of claim 8, wherein the processor-executable instructions, when executed by the one or more processors, cause the analysis and control system to continuously monitor the one or more sensors to automatically detect the deviations of the one or more outputs of the model of the physical system relative to the data collected by the one or more sensors associated with the physical system during operation of the physical system.

13. The analysis and control system of claim 8, wherein the processor-executable instructions, when executed by the one or more processors, cause the analysis and control system to utilize the transfer learning or adaptation techniques on a state-space formulation of the model of the physical system to adapt the model of the physical system.

14. The analysis and control system of claim 8, wherein the model of the physical system comprises a recurrent neural network (RNN).

15. A non-transitory computer readable medium, comprising:
processor-executable instructions, which when executed by one or more processors of an analysis and control system, cause the analysis and control system to:
initially train a model of a physical system, wherein the model of the physical system comprises a data-driven model or a hybrid model that comprises a combination of a physics-based definition of the physical system and data collected relating to the physical system;
detect deviations of one or more outputs of the model of the physical system relative to data collected by one or more sensors associated with the physical system during operation of the physical system;
determine that degradation in an ability of the model of the physical system to estimate performance of the physical system has occurred based at least in part on the detected deviations;
utilize transfer learning or adaptation techniques of the model of the physical system to adapt the model of the physical system; and
estimate a Remaining Useful Life (RUL) of the physical system based on the adapted model of the physical system.

16. The non-transitory computer readable medium of claim 15, wherein the processor-executable instructions, when executed by the one or more processors of the analysis and control system, cause the analysis and control system to utilize Jacobian Feature Regression (JFR) of the model of the physical system to adapt the model of the physical system.

17. The non-transitory computer readable medium of claim 15, wherein the processor-executable instructions, when executed by the one or more processors of the analysis and control system, cause the analysis and control system to automatically control one or more operational parameters of the physical system based at least in part on the estimated RUL of the physical system.

18. The non-transitory computer readable medium of claim 15, wherein the processor-executable instructions, when executed by the one or more processors of the analysis and control system, cause the analysis and control system to determine that the degradation in the ability of the model of the physical system to estimate the performance of the physical system has occurred, in response to detecting that the deviations of the one or more outputs of the model of the physical system relative to the data collected by the one or more sensors associated with the physical system are greater than predetermined thresholds.

19. The non-transitory computer readable medium of claim 15, wherein the processor-executable instructions, when executed by the one or more processors of the analysis and control system, cause the analysis and control system to continuously monitor the one or more sensors to automatically detect the deviations of the one or more outputs of the model of the physical system relative to the data collected by the one or more sensors associated with the physical system during operation of the physical system.

20. The non-transitory computer readable medium of claim 15, wherein the processor-executable instructions, when executed by the one or more processors of the analysis and control system, cause the analysis and control system to utilize the transfer learning or adaptation techniques on a state-space formulation of the model of the physical system to adapt the model of the physical system.
